(19) United States
(12) Patent Application Publication
(10) Pub. No.: US 2004/0198445 A1
(43) Pub. Date: Oct. 7, 2004

(54) Communication device controller

(76) Inventor: Chih-Yuan Hsueh, Pa Teh City (TW)

Correspondence Address: RABIN & BERDO, P.C., Suite 500, 1101 14th Street, N.W., Washington, DC, 20005, US

(21) Appl. No.: 10/212,881

(22) Filed: Aug. 7, 2002

(51) Int. Cl. H04B 1/38

(52) U.S. Cl. 455/558; 455/557; 455/550.1

(57) ABSTRACT

A communication device controller comprising: a signal receive/send unit with a SIM socket used for mobile communication system; a signal process unit connected to a plurality of phone lines and said signal receive/send unit; and a power supply unit providing stable power for said signal receive/send unit and said signal process unit; whereby said communication device controller been settled in the field where electrical signal is more stronger and using telephones to send/receive cellular phone could achieve the functions of using cellular phones instead of telephones in the field where hard to set up wires of telephones and amplifying a plurality of extensive phones indoor.

### BACKGROUND OF THE INVENTION

1. Field of the Invention

The present invention relates a communication device controller and more specially to a communication device been settled in the field where electrical signal is more stronger and using telephones to send/receive cellular phone could achieve the functions of using cellular phones instead of telephones in the field where hard to set up wires of telephones and amplifying a plurality of extensive phone indoor.

2. Description of the Prior Art

Following the technology changing with each passing day, communicative skill advancing day-by-day and government policy liberating, the communicative quality of cellular phone has been improved by way of setting station widely. Populations of using cellular phone increase by exponentially rate, meanwhile the fee cost of cellular phone relatively lower than that was.

Before cellular phones using as communication tools, every home or individual user must apply to the communication system providers for wiring telephones lines from station or divider to the user terminal. In the city, the telephones net has been developed perfectly, so that to set telephones lines is easily and quickly. Nevertheless, in the wild area, especially in secluded area, it will cost long period to wire telephones lines and connect the user terminals and the communication system providers.

After developing cellular phones, for sake of convenient and wireless characteristics, it attracts many persons quickly. Especially, in contrast to conventional telephones, mobile system overcomes the defects of long-distance wire and set-up of telephones system. However, one cellular phone do not have extensive function for other users.

Furthermore, the mountains, high buildings and other wave generators usually influence the communicative signal of cellular phones from the station.

### SUMMARY OF THE INVENTION

A primary object of the present invention is to provide a communication device controller, wherein by way of setting said communication device controller in the field where electrical signal is more stronger and using telephones to send/receive cellular phone could achieve the functions of using cellular phones instead of telephones in the field where hard to set up wires of telephones and amplifying a plurality of extensive phone indoor.

Another object of the present invention is to provide a communication device controller, wherein said communication device controller could be connected to the computers and faxes through telephones lines and achieve the functions of surfing Internet and transmitting digital dates.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows the structure diagram of the present invention;

FIG. 2 shows the block diagram of the present invention;

FIG. 3 shows the use of the present invention.

### DETAILED DESCRIPTION OF THE INVENTION

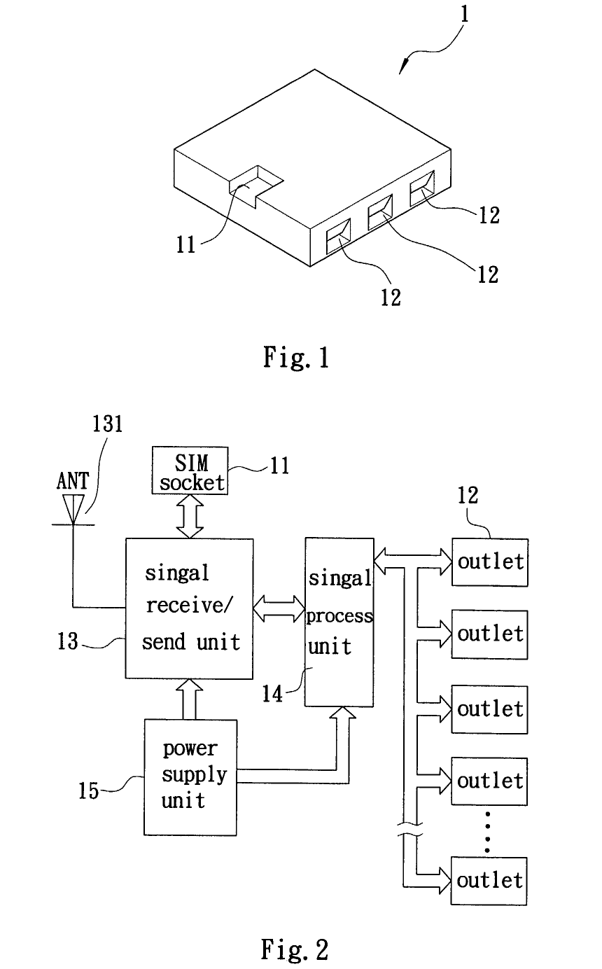

Please refer to FIG. 1 and FIG. 2 that show the structure diagram and the block diagram of the present invention, respectively. As those shown, the communication device controller of this present invention possesses a outer part having a SIM socket (11) and a plurality of outlets (12), which could be plugged by telephones terminals and a inner part at least comprising of:

a signal receive/send unit (13), being connected to said SIM socket (11) and possessing an antenna (131), which is a communication mediator for signal send/receive unit (13) and mobile systems and furthermore possesses a variety of communication functions as well as cellular phones;

a signal process unit (14), being the mediator between a plurality of outlets (12) and said signal send/receive unit (13) and capable of transforming signals from outlets (12) to signals of cellular phone and then signals may be sent by said antenna (131) of said signal receive/send unit (13); and also capable of transforming signals from said signal send/receive unit (13) to signals of telephones and then deliver to outlets (12); and

a power supply unit (15), being capable of providing stable power to said signal send/receive unit (13) and said signal process unit (14),

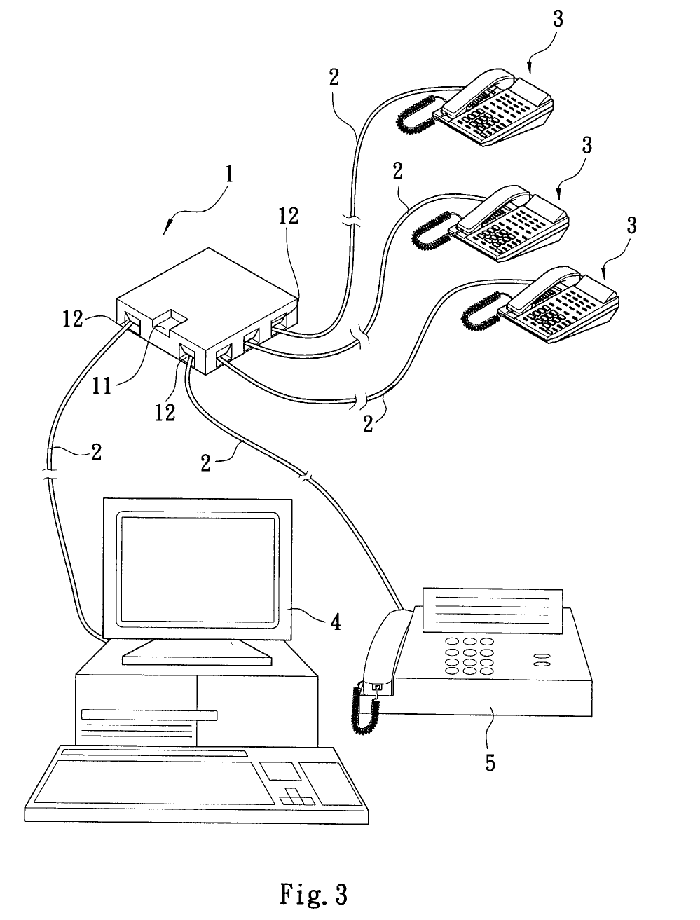

Please refer to FIG. 3 that shows the use of the present invention, wherein the outlets (12) of the communication device controller (1) are connected to the telephones (3) via telephones lines (2). After plugging the SIM card into the SIM socket (11), the user's cellular phone could have the advantages of extensive function as well as telephones, so that one cellular phone could be use by multiple persons.

Besides, users just need to set the communication device controller (1) on the place, which could receive the signal of mobile system well, and then they could use the telephones in the basement or other places where the signal is weak or may be influenced by electronic noise, so that users by way of using this present invention will get high quality of voice communication.

Furthermore, the communication device controller (1) is also connected to computer (4) and fax (5), so that users could surf the Internet through computer (4) and use fax (5) to transmit documents or information to another fax with wireless cellular phone.

As mentioned above, we use the communication device controller (1) to connect the cellular phone and telephones and it will get the well communicative quantity and extensive function of wire-telephones and the convenient properties of the mobile system of cellular phone simultaneously.

What is claimed is:

1. A communication device controller comprising:
a signal receive/send unit with a SIM socket used for mobile communication system;
a signal process unit connected to a plurality of phone lines and said signal receive/send unit; and
a power supply unit providing stable power for said signal receive/send unit and said signal process unit;
whereby said communication device controller been settled in the field where electrical signal is more stronger and using telephones to send/receive cellular phone could achieve the functions of using cellular phones instead of telephones in the field where hard to set up wires of telephones and amplifying a plurality of extensive phones indoor.

2. The communication device controller according to claim 1 wherein said signal send/receive unit is connected to SIM socket and possesses an antenna, which is a communication mediator for signal send/receive unit and mobile systems and furthermore possesses a variety of communication functions as well as cellular phones.

3. The communication device controller according to claim 1 wherein said signal process unit is the mediator between a plurality of outlets and said signal send/receive unit and capable of transforming signals from outlets to signals of cellular phone and then signals may be sent by said antenna of said signal receive/send unit; and also capable of transforming signals from said signal send/receive unit to signals of telephones and then deliver to outlets.

4. The communication device controller according to claim 1 wherein said power supply unit is capable of providing stable power to said signal send/receive unit and said signal process unit.

5. The communication device controller according to claim 3 wherein said outlets are capable of connecting to computers via telephones lines.

6. The communication device controller according to claim 1 wherein said outlets are capable of connecting to faxes via telephones lines.
